(19) United States
(12) Patent Application Publication
(10) Pub. No.: US 2024/0227003 A1
(43) Pub. Date: Jul. 11, 2024

(54) DIAMOND-BASED NANOPARTICLE AND NANOCOMPOSITE ALLOY

(71) Applicant: POWERUP, INC., Grand Blanc, MI (US)

(72) Inventor: Alexander M. Derderian, Grand Blanc, MI (US)

(21) Appl. No.: 18/559,086

(22) PCT Filed: May 5, 2022
(86) PCT No.: PCT/US2022/027934

§ 371 Date: Nov. 6, 2023

Related U.S. Application Data
(60) Provisional application No. 63/184,465, filed on May 5, 2021.

(51) Int. Cl. B22F 1/16

(52) U.S. Cl. CPC B22F 1/16; B22F 2301/058; B22F 2302/406; B22F 2303/20

(57) ABSTRACT

A nanomaterial includes a powder that is comprised of composite particles. Each of the composite particles has a magnesium-rich metal core particle that defines an external surface and exposed nanodiamond particles that are bonded to the external surface and functionalized with amine. Also disclosed is a method for fabrication of the composite particles via a milling.

### BACKGROUND

Magnesium, either in substantially pure form or as a magnesium alloy, is highly desirable for use in a wide variety of end-use components. In general, in comparison to steel or other alloys, magnesium is light weight, has a high strength-to-weight ratio, has a high stiffness-to-weight ratio, and is manufacturable as a cast or wrought alloy.

Powder metallurgy encompasses a wide range of processing techniques for producing end-use components from raw material powders. For example, some materials that are not readily melt-processible, as in a casting process, may be formed into end-use components from a powder. Typically, the powder is compacted to form a green part that is then sintered to form a component. The component may then be subjected to further processing, such as finishing, machining, and heat treatment, depending on the desired properties for the end-use application. Conversely, there are other materials, such as magnesium-rich metal materials, that may be melt-processed and worked as a bulk material but that are not amenable to powder metallurgy. For example, at sizes of interest for powder metallurgy, magnesium powder is pyrophoric and may thus spontaneously ignite in air. As a result, powder metallurgy processing of magnesium-rich materials has been limited.

### SUMMARY

A nanomaterial according to an example of the present disclosure includes a powder comprised of composite particles. Each of the composite particles has a magnesium-rich metal core particle that defines an external surface and exposed nanodiamond particles bonded to the external surface.

In a further example of any of the foregoing embodiments, the exposed nanodiamond particles are mechanically bonded to the external surface.

In a further example of any of the foregoing embodiments, the exposed nanodiamond particles are electrically bonded to the external surface.

In a further example of any of the foregoing embodiments, each of the exposed nanodiamond particles is spherical, has a diameter of 1 nanometer to 30 nanometers, and has an amorphous carbon exterior.

In a further example of any of the foregoing embodiments, the amorphous carbon exterior is functionalized such that each of the nanodiamond particles has a negative zeta potential.

In a further example of any of the foregoing embodiments, the negative zeta potential is −30 millivolts or greater and is less than zero millivolts.

In a further example of any of the foregoing embodiments, the amorphous carbon exterior is functionalized with amine functional groups.

In a further example of any of the foregoing embodiments, the magnesium-rich metal core particle is pure magnesium.

In a further example of any of the foregoing embodiments, the magnesium-rich metal core particle is a magnesium alloy.

In a further example of any of the foregoing embodiments, the magnesium alloy has one or more alloy elements independently selected from the group consisting of aluminum, zinc, manganese, silicon, gadolinium, yttrium, and neodymium.

In a further example of any of the foregoing embodiments, each of the composite particles has, by weight, from 0.1% to 30% of the exposed nanodiamond particles.

In a further example of any of the foregoing embodiments, each of the composite particles has, by weight, from 0.2% to 0.4% of the exposed nanodiamond particles.

In a further example of any of the foregoing embodiments, the magnesium-rich metal core particles without the nanodiamond particles bonded to the external surface have a core particle ignition temperature, and the composite particles have a composite particle ignition temperature that is greater than the core particle ignition temperature.

A method for fabricating a nanomaterial according to an example of this disclosure includes introducing magnesium-rich metal core particles, nanodiamond particles, and milling media into a milling container. The magnesium-rich metal core particles are comprised of particle sizes that are larger than −100 Mesh. The milling container is then rotated, and the milling media acts to impact the magnesium-rich metal core particles and the nanodiamond particles to bond the nanodiamond particles to an external surface of the magnesium-rich metal core particles to thereby form composite particles of the magnesium-rich metal core particles and nanodiamond particles bonded and exposed on the external surface.

In a further example of any of the foregoing embodiments, the milling container includes an inert cover gas during the rotating, the rotating produces heat in the milling container and, after conclusion of the rotating, further including subjecting the composite particles in the milling container to a cooling cycle to cool the composite particles to a predetermined temperature in the milling container while under the inert cover gas in the milling container, followed by venting the milling container to ambient air once the predetermined temperature is reached.

In a further example of any of the foregoing embodiments, the cooling cycle is selected based upon amounts, by weight, of the nanodiamond particles and the magnesium-rich metal core particles introduced into the milling container.

In a further example of any of the foregoing embodiments, the milling media includes milling balls, and a weight ratio of the milling balls to a combined weight of the magnesium-rich metal core particles and the nanodiamond particles is from 1:1 to 50:1.

A further example of any of the foregoing embodiments includes introducing stearic acid into the milling container with the magnesium-rich metal core particles, the stearic acid reducing adherence of the composite particles to the milling media.

The present disclosure may include any one or more of the individual features disclosed above and/or below alone or in any combination thereof.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example nanomaterial in the form of a composite particle of a powder.

FIG. 2 illustrates an example nanodiamond particle.

FIG. 3 illustrates an example of a functionalized nanodiamond particle.

FIG. 4 illustrates a method for fabricating a nanomaterial.

In this disclosure, like reference numerals designate like elements where appropriate and reference numerals with the addition of one-hundred or multiples thereof designate modified elements that are understood to incorporate the same features and benefits of the corresponding elements.

### DETAILED DESCRIPTION

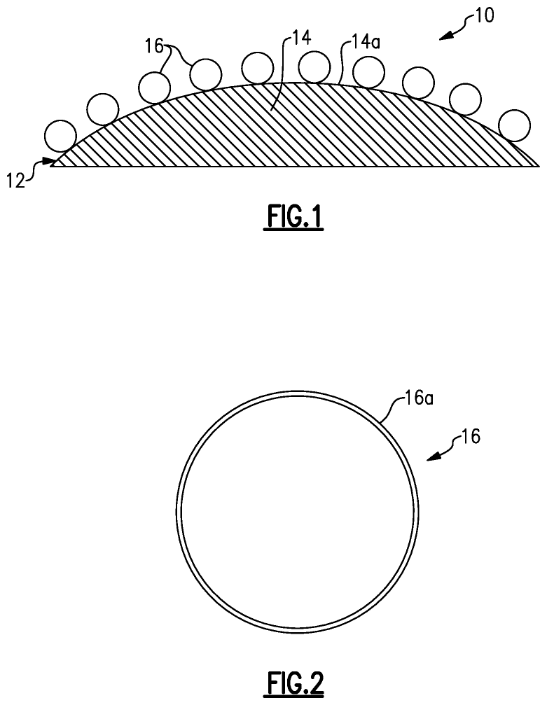

FIG. 1 illustrates a nanomaterial 10 in the form of a composite particle 12. A representative portion of the composite particle 12 is shown and, as will be appreciated, a flowable collection of dry bulk composite particles 12 constitutes a powder.

Each composite particle 12 of the powder is comprised of a magnesium-rich metal core particle 14 and a plurality of nanodiamond particles 16. The magnesium-rich metal core particle 14 defines an external surface 14a. The external surface 14a is the outside peripheral surface of the magnesium-rich metal core particle 14, as opposed to an internal surface (e.g., of a pore) or internal boundary between phases or grains. At least a portion of the nanodiamond particles 16 are bonded to the external surface 14a and are exposed rather than embedded in another material or in the magnesium-rich metal core particle 14. The bonding may be mechanical bonding, electrical bonding, or combinations thereof.

Due to high surface reactivity and surface area to weight ratio, magnesium powders at sizes of interest for powder metallurgy are generally pyrophoric, which limits their use in powder processes. However, the bonding of the nanodiamond particles 16 to the surface of the magnesium-rich metal core particle 14 renders the surface less reactive (e.g., with oxygen) and thus enables use of the composite particles 12 in powder metallurgy processing. The nanodiamond particles 16 increase the ignition temperature of the composite particles 12 (as compared to the magnesium-rich metal core particle 14 alone, without the nanodiamond particles 16) and enable handling with lower chance of ignition.

Each of the composite particles 12 has a composition, by weight, that generally contains from 0.1% to 30% of the nanodiamond particles 16 and a remainder made up of the magnesium-rich metal core particle 14 and any impurities. At levels of the nanodiamond particles 16 that are greater than 0.2%, such as 0.4%, the composite particles 12 can be handled in an oxygen-rich environment (>50%) at elevated thermal states above approximately 70° C. without spontaneous ignition. Consequently, the powder can be used in downstream powder metallurgy processing to form end-use components from magnesium-rich metal nanocomposites. At amounts below 0.2% down to about 0.1% there may be less of an increase in the ignition temperature. Depending on the particular implementation and downstream process parameters, such a modest increase may or may not be acceptable. Thus, for a substantial ignition temperature increase, use of at least 0.2% may be used and use of at least 0.4% may be used for an ignition temperature increase and handling in oxygen-rich environments. Amounts above 0.4%, such as 1% or 5% may be used to increase ignition temperature, enable handling, and to modify mechanical properties of the end-use component that is formed from the composite powder 12 and/or to modify processing characteristics of the composite powder 12 for processes that are used to form the end-use component. At levels below 0.1% it is possible that there may be an increase in the ignition temperature; however, even if the increase would be enough to enable powder metallurgy processing of the composite particles 12, the cooling cycle times in the fabrication process to make the composite particles 12 would be impractical. At levels of 20% and above, the nanodiamond particles 16 are expected to have stronger influence on mechanical properties of the end-use component, which may or may not be acceptable.

FIG. 2 illustrates a representative one of the nanodiamond particles 16. As shown, the nanodiamond particle 16 is spherical. Other geometries of the nanodiamond particle 16 may be used, but spherical geometry ultimately provides a more homogenous microstructure in end-use components that are fabricated using the composite particles 12. In one example, the nanodiamond particle 16 is produced in a known manner via a detonation process to provide the spherical geometry as well as an amorphous carbon surface 16a. The nanodiamond particle 16 has a diameter that is from 1-30 nanometers. Larger sizes may increase porosity in end-use components produced from the powder, which may or may not be desirable.

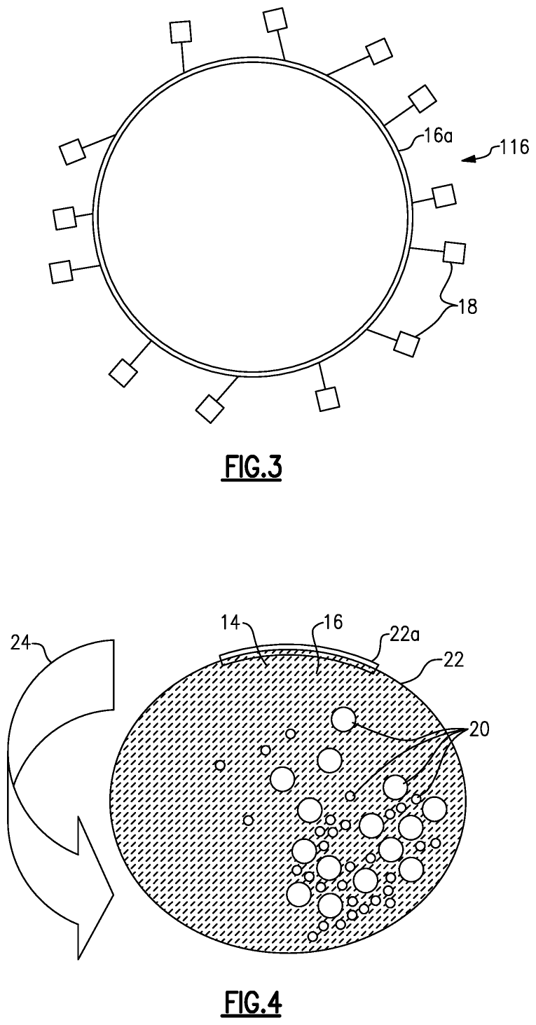

FIG. 3 illustrates a further example of a nanodiamond particle 116. The nanodiamond particle 116 is the same as the nanodiamond particle 16 except that the amorphous carbon exterior 16a has functional groups 18 bonded thereto that serve to promote electrical bonding with the magnesium-rich metal core particles 14. For instance, the functional groups 18 provide a negative zeta potential at the amorphous carbon exterior 16a of the nanodiamond particle 116. The surfaces 14a of the magnesium-rich metal core particles 14 carry a positive electrical charge. The negative zeta potential serves to generate adequate attraction with positively charged surface of the magnesium-rich metal core particles 14 for electrical bonding, yet limit agglomeration of the nanodiamond particles 116. For example, the negative zeta potential is −30 millivolts or greater and is less than zero millivolts. The functional groups 18 are not particularly limited as long as they are capable of providing the above zeta potential. One example of the functional groups 18 that is useful for achieving the above zeta potential are amine groups. Higher zeta potentials up to about 30 millivolts may also be used but may not serve for attraction to the positively charged magnesium-rich metal core particles 14 and may thus primarily act to limit agglomeration. In that case, the nanodiamond particles 16 will need to rely on mechanical bonding to the magnesium-rich metal core particles 14.

The magnesium-rich metal core particle 14 is pure magnesium or a magnesium alloy. For instance, pure magnesium is at least 99% pure, by weight, such as at least 99.8% or at least 99.9%, with the remaining <1% constituting impurities that do not materially affect the properties. The magnesium alloy includes, by weight, greater than 50% magnesium, or more typically greater than 80% magnesium. In a further example, the magnesium-rich metal core particle 14 is a magnesium alloy that has one or more alloy elements independently selected from aluminum, zinc, manganese, silicon, gadolinium, yttrium, and neodymium. Further example compositions of the magnesium-rich metal core particle 14 are disclosed in the working examples below.

As indicated above, the bonding of the exposed nanodiamond particles 16 to the surface of the magnesium-rich metal core particle 14 reduces the reactivity of the external surface 14a of the magnesium-rich metal core particle 14 and thus enables use of the composite particles 12 in powder metallurgy processing. As an example, the magnesium-rich metal core particles 14 without the nanodiamond particles 16 bonded to the external surface 14a have a core particle ignition temperature (in air), and the composite particles 12 have a composite particle ignition temperature that is greater than the core particle ignition temperature. Baselines for these may be relative to pure magnesium, which has an auto-ignition temperature of approximately 473° C., and auto-ignition temperatures of magnesium alloys that are known or estimated from literature. For example, a magnesium alloy known under the designation AZ91D has an auto-ignition temperature of approximately 600° C. The increase of the ignition temperature due to the nanodiamond particles 16 bonded to the magnesium-rich metal core particles 14 enables the composite particles 12 to be used, without ignition, in downstream powder metallurgy processes that could not be previously practiced with magnesium powders due to the reactivity of magnesium.

FIG. 4 depicts an example of a method for fabricating the nanomaterial 10 described above (incorporated herein by reference). The method includes introducing the magnesium-rich metal core particles 14, the nanodiamond particles 16, and milling media 20 into a milling container 22 (e.g., a jar). The relative amounts of the magnesium-rich metal core particles 14 and the nanodiamond particles 16 are selected in accordance with the desired end composition of the composite particles 12. The magnesium-rich metal core particles 14 are, at least initially, comprised of particle sizes that are larger than −100 mesh. Such particle sizes are large enough that the magnesium-rich metal core particles 14 are not substantially pyrophoric under the conditions used in the disclosed method.

Once the magnesium-rich metal core particles 14, the nanodiamond particles 16, and milling media 20 are loaded into the milling container 22, the container 22 is rotated, as indicated by arrow 24. The direction of rotation may be reversed during the process. The milling media 20 impacts the magnesium-rich metal core particles 14 and the nanodiamond particles 16, thereby mechanically bonding the nanodiamond particles 16 to the external surface 14a of the magnesium-rich metal core particles 14 to form the composite particles 12. For instance, the mechanical bonding occurs through physical deformation of the surface 14a of the magnesium-rich metal core particles 14 such that the nanodiamond particles 16 partially embed into the surface 14a. Moreover, frictional heat from particles collisions during the milling may serve to soften the magnesium-rich metal core particles 14 and thereby facilitate deformation. If the functionalized nanodiamond particles 116 are used, the rotation also mixes the magnesium-rich metal core particles 14 and the nanodiamond particles 116, bringing the nanodiamond particles 116 into localized proximity of the magnesium-rich metal core particles 14 such that the functional groups 18 are attracted to, and bond with, the positive charge carriers of the magnesium-rich metal core particles 14.

Prior to loading of the initial magnesium-rich metal core particles 14 into the container 22, the magnesium-rich metal core particles 14 may be produced from an alloy ingot. For example, the constituent elements of the magnesium-rich metal core particles 14 are combined in a melting and casting process to produce an alloy ingot. The ingot may then be post-processed by, but not limited to, casting, die casting, extruding, and forging. The ingot may then be chipped, atomized, ground, or processed through similar means to produce the initial magnesium-rich metal core particles 14. Alternatively, the individual constituent elements of the magnesium-rich metal core particles 14 may be atomized to form the magnesium-rich metal core particles 14. The initial magnesium-rich metal core particles 14 that result from any of the above processes may then be further processed in a mechanical alloying process to develop a powder particle form. Mechanical alloying facilitates lower alloy contamination, a higher degree of homogeneity than other processes such as injection molding or casting, and a finer particle size distribution.

Optionally, if not already at the target starting size, the initial magnesium-rich metal core particles 14 may be milled to reduce to the target starting size. For instance, the initial magnesium-rich metal core particles 14 have a size of approximately 1.2 millimeters inches to 6.4 millimeters, and in some cases may be larger. The milling reduces the size to 100 to 500 microns, creates a more uniform particle shape, and increases the surface area to weight ratio. The increase in surface area to weight ratio increases the surface area that is available for bonding with the nanodiamond particles 16. Milling of the magnesium-rich metal core particles 14 prior to the incorporation of the nanodiamond particles 16 can, under some conditions with exposure to oxygen, result in ignition. Therefore, the majority of the resulting magnesium-rich metal core particles 14 from this initial milling step have a particle size that is larger than −100 mesh. However, depending on the size and geometry of the initial magnesium-rich metal core particles 14, initial mechanical milling may not be needed.

In one example, the introduction of the magnesium-rich metal core particles 14 and the nanodiamond particles 16 into the container 22 includes first combining these materials in a clean, dry glass laboratory flask. Drying the flask beforehand may facilitate reducing the presence of liquids, including deionized water, that can undesirably expose the magnesium to oxygen prior to bonding the nanodiamond particles 16. Oxygen can react with the magnesium, creating oxides that inhibit bonding of the nanodiamond particles 16. In a further example, a processing agent is also introduced into the container 22 and serves to reduce bonding of the composite particles 12 to the milling media 20. For instance, the processing agent is stearic acid and may be in the form of solid flakes that range in cross-sectional area from approximately 1.6 square millimeters to 41 square millimeters. As an example, from approximately 0.5% to 2% by weight of the stearic acid is used based on the total combined weight of the magnesium-rich metal core particles 14 and the nanodiamond particles 16. In one example, the amount of approximately 0.75%.

The container 22 and milling media 20 are made of stainless steel or ceramic materials. Use of ferrous based materials may be avoided due to abrasion that can result in undesired contaminant particles. As an example, a weight ratio of the milling media 20, such a milling balls, to the combined weight of the magnesium-rich metal core particles 14 and the nanodiamond particles 16 is from 1:1 to 50:1 or more. Most typically, the milling media 20 are milling balls that are of a common diametric size or of two or more different diametric sizes.

The milling container 22 may include an aeration lid 22a that seals the solid contents in the container 22 but permits an inert cover gas to be provided into the container 22, or alternatively the container 22 to be evacuated. The inert cover gas is a gas or mixture of gases that are non-reactive with the magnesium-rich metal core particles 14, the nanodiamond particles 16, and the composite particles 12 under the conditions of the milling process. For instance, the inert cover gas is substantially pure nitrogen, substantially pure argon, or a mixture thereof. The inert cover gas may serve to remove heat that is generated during the process, e.g., from friction. In this regard, nitrogen may facilitate greater heat removal in comparison to argon, as well as reduce particle agglomeration. The pressure of the inert cover gas in the container 22 may be selected in accordance with the process duration, container size, aeration lid 22a properties, and the amounts of magnesium-rich metal particles 14 and nanodiamond particles 16 to adjust the absorption and loss of the inert cover gas during the process.

The parameters of the milling process of the magnesium-rich metal particles 14 and the nanodiamond particles 16 may include time, direction of rotation, rotations per minute, weight ratio of milling media to the combined amount of the magnesium-rich metal particles 14 and the nanodiamond particles 16 (i.e., sample size), type of inert cover gas, inert cover gas pressure, target composition of the composition particles 12, and processing agent. Non-limiting working examples of such parameters are provided below. As will be appreciated, these parameters are not particularly limited and may be varied for a particular implementation.

After completion of the milling, the container 22 is vented to release any back-pressure of the inert cover gas. The milling results in a reduction in particle size such that the composite particles 12 are smaller than the size of the starting magnesium-rich metal particles 14. As the particle size reduces, the total thermal energy of the system increases. As the increase in the ignition temperature corresponds to the amount of the nanodiamond particles 16, the amount of the nanodiamond particles 16 used may be selected to provide an increase in the ignition temperature that is commensurate with the thermal energy of the system, to prevent ignition.

After completion of the milling, the composite particles 12 are in a thermally excited state. Although the external surfaces 14a surfaces of the magnesium-rich metal particles 14 have bonded with the nanodiamond particles 16, a small percentage of the magnesium rich metal particles 16 or portions thereof may be unbound and, therefore, reactive with oxygen at a lower ignition temperature than the formed composite particle 12 with bonded nanodiamond particles 16. To facilitate a reduction in the chances of ignition after milling, the system is subjected to a cooling cycle while under the inert cover gas in the milling container 22 to reduce the system to a predetermined temperature at which the contents can be vented to ambient air with reduced chance of ignition. The cooling cycle may be selected based upon the amounts, by weight, of the nanodiamond particles 16 and the magnesium-rich metal core particles 14 that were introduced into the container 22. For example, a relatively higher amount of the nanodiamond particles 16 in the prescribed range results in a greater increase in ignition temperature and thus may require less cooling, while relatively lower amounts of the nanodiamond particles 16 in the prescribed range result in a lower increase in ignition temperature may require more cooling.

Cooling of the composite particles 12 post milling is dependent on the cycle time of the milling process. As the cycle time of the milling process increases, the cooling time for composite particles 12 will increase. This is caused by the heat generated from the collisions of the milling media 20 and particles 14/16 within the milling container 22. Further, the amount of nanodiamond particles 16 dictates the ignition temperature associated with the composite particles 12 that are produced. Therefore, as the level of nanodiamond particles 16 of the composition increases, the temperature for exposing the composite particles 12 to oxygen without causing ignition increases, thereby reducing the cooling time.

After cooling, the composite particles 12 may be inspected through filtering to determine process efficacy and yield from the post-milling state of the composite particles 12. Automatic or manual mesh filtering may be used to separate the composite particles 12 by size. The percentage of each mesh range may be compared to a master sample to confirm process efficacy. Non-limiting examples of this mesh filtering are included in the working examples below. The resulting weight of the composite particles 12 may be measured on a scale to determine yield when divided against the input amount of starting materials prior to milling. High intensity magnification, spectroscopy, or other inspection method may also be used to confirm surface bonding and composition of the composite particles 12.

The nanodiamond particles 16 in the composition of the composite particles 12 provide numerous benefits that no other single type of nanoparticle is expected to provide. In addition to increasing the ignition temperature, the nanodiamond particles 16 do not form galvanic couples with the underlying magnesium-rich metal core particles 14. Galvanic coupling may otherwise lead to degradation in downstream processes or end-uses, which is avoided via use of the nanodiamond particles 16. Moreover, although the nanodiamond particles 16 may be used at higher levels, it is effective at low levels to modify ignition temperature and mechanical properties, thus lowering materials costs.

The following non-limiting examples demonstrate additional aspects of the present disclosure, including compositions of starting magnesium-rich core particles, milling parameters and inert cover gas for pre-milling of starting magnesium-rich core particles, milling parameters for bonding the nanodiamond particles to the magnesium-rich core particles, composite particle compositions, and characterization of density and powder size distribution.

### Example 1

Ingot Chip Elemental Composition

| | | | |
|---|---|---|---|
| Magnesium | 86.6% | 173.2 | grams |
| Gadolinium | 8.2% | 16.4 | grams |
| Yttrium | 3.8% | 7.6 | grams |
| Zinc | 1.0% | 2.0 | grams |
| Zirconium | 0.4% | 0.8 | grams |

Mechanical Grinding from Ingot Chip Process Parameters

| Jar Volume | 1000 | milliliters |
|---|---|---|
| Jar Material | 302 Stainless Steel | |
| Agitating Ball Mass | 32 | grams |
| Agitating Ball Diameter | 20 | millimeters |
| Agitating Ball Material | 316 Stainless Steel | |
| Agitating Ball to | 4:1 | |
| Sample Mass Ratio | | |
| Vacuum | No | |
| Cover Gas | No | |
| Back Pressure | None | |
| Sample Weight | 200 | grams |
| Milling Time | 45 | minutes |
| Milling RPMs | 550 rotations per | |
| | minute | |
| Milling Direction | Clockwise (5-minute | |
| | intervals | |
| Milling Direction | Counterclockwise | |
| | minute (5-intervals) | |
| Milling Pause | 10 | seconds |

Composite Particle Elemental Composition

| | | | |
|---|---|---|---|
| Magnesium | 86.5% | 173.6 | grams |
| Gadolinium | 8.2% | 16.4 | grams |
| Yttrium | 3.8% | 7.6 | grams |
| Zinc | 1.0% | 2.0 | grams |
| Zirconium | 0.4% | 0.8 | grams |
| Nanodiamond | 0.4% | 0.8 | grams |
| Terminated | | | |
| with Amine | | | |
| Functional | | | |
| Group (2-5 | | | |
| nanometer | | | |
| spherical) | | | |

Mechanical Grinding from Ingot Chip Process Parameters

| Jar Volume | 1000 | milliliters |
|---|---|---|
| Jar Material | 302 Stainless Steel | |
| Agitating Ball 1 Mass | 32 | grams |
| Agitating Ball 1 Diameter | 20 | millimeters |
| Agitating Ball 1 to Sample | 4:1 | |
| Mass Ratio | | |
| Agitating Ball 2 Mass | 4 | grams |
| Agitating Ball 2 Diameter | 10 | millimeters |
| Agitating Ball 2 to Sample | 2.5:1 | |
| Mass Ratio | | |
| Agitating Ball Material | 316 Stainless Steel | |
| Vacuum | No | |
| Cover Gas | Nitrogen | |
| Back Pressure | 15 Pounds per | |
| | Square Inch | |
| Sample Weight | 200 | grams |
| Milling Time | 480 | minutes |
| Milling RPMs | 550 rotations | |
| | per minute | |
| Milling Direction | Clockwise | |
| | (30-minute intervals | |
| Milling Direction | Counterclockwise | |
| | (30-minute intervals) | |
| Milling Pause | 60 | seconds |

| | Percent Yield |
|---|---|
| | from Mechanical |
| Filter Mesh Size | Alloying Process |
| +40 Mesh | 0.1% |
| +100 Mesh | 14.6% |
| +200 Mesh | 52.8% |
| +325 Mesh | 15.7% |
| −325 Mesh | 16.8% |

| | |
|---|---|
| Apparent | 0.921 grams percentimeter |
| Density | cubed |

### Example 2

Ingot Chip Elemental Composition

| | | | |
|---|---|---|---|
| Magnesium | 86.6% | 173.2 | grams |
| Gadolinium | 8.2% | 16.4 | grams |
| Yttrium | 3.8% | 7.6 | grams |
| Zinc | 1.0% | 2.0 | grams |
| Zirconium | 0.4% | 0.8 | grams |

Mechanical Grinding from Ingot Chip Process Parameters

| Jar Volume | 1000 | milliliters |
|---|---|---|
| Jar Material | 302 Stainless Steel | |
| Agitating Ball Mass | 32 | grams |
| Agitating Ball Diameter | 20 | millimeters |
| Agitating Ball Material | 316 Stainless Steel | |
| Agitating Ball to | 4:1 | |
| Sample Mass Ratio | | |
| Vacuum | No | |
| Cover Gas | No | |
| Back Pressure | None | |
| Sample Weight | 200 | grams |
| Milling Time | 45 | minutes |
| Milling RPMs | 550 rotations | |
| | per minute | |
| Milling Direction | Clockwise | |
| | (5-minute intervals | |
| Milling Direction | Counterclockwise | |
| | (5-minute intervals) | |
| Milling Pause | 10 | seconds |

Composite Particle Elemental Composition

| | | | |
|---|---|---|---|
| Magnesium | 86.5% | 173.6 | grams |
| Gadolinium | 8.2% | 16.4 | grams |
| Yttrium | 3.8% | 7.6 | grams |
| Zinc | 1.0% | 2.0 | grams |
| Zirconium | 0.4% | 0.8 | grams |
| Nanodiamond Terminated (2-5 | 0.4% | 0.8 | grams |
| nanometer spherical) | | | |

Mechanical Grinding from Ingot Chip Process Parameters

| Jar Volume | 1000 | milliliters |
|---|---|---|
| Jar Material | 302 Stainless Steel | |
| Agitating Ball 1 Mass | 32 | grams |
| Agitating Ball 1 Diameter | 20 | millimeters |
| Agitating Ball 1 to | 4:1 | |
| Sample Mass Ratio | | |
| Agitating Ball 2 Mass | 4 | grams |
| Agitating Ball 2 Diameter | 10 | millimeters |
| Agitating Ball 2 to | 2.5:1 | |
| Sample Mass Ratio | | |
| Agitating Ball Material | 316 Stainless Steel | |
| Vacuum | No | |
| Cover Gas | Nitrogen | |
| Back Pressure | 15 Pounds per | |
| | Square Inch | |
| Sample Weight | 200 | grams |
| Milling Time | 480 | minutes |
| Milling RPMs | 550 rotations | |
| | per minute | |
| Milling Direction | Clockwise | |
| | (30-minute intervals | |
| Milling Direction | Counterclockwise | |
| | (30-minute intervals) | |
| Milling Pause | 60 | seconds |

| | |
|---|---|
| | Percent Yield from |
| Filter Mesh | Mechanical Alloying |
| Size | Process |

| | | |
|---|---|---|
| +40 | Mesh | 0.1% |
| +100 | Mesh | 14.6% |
| +200 | Mesh | 52.8% |
| +325 | Mesh | 15.7% |
| −325 | Mesh | 16.8% |

| | |
|---|---|
| Apparent | 0.921 grams per centimeter cubed |
| Density | |

### Example 3

Ingot Chip Elemental Composition

| | | | |
|---|---|---|---|
| Magnesium | 89.8% | 179.6 | grams |
| Aluminum | 9.0% | 18.0 | grams |
| Zinc | 0.7% | 1.4 | grams |
| Manganese | 0.4% | 0.8 | grams |
| Silicon | 0.1% | 0.2 | grams |

Mechanical Grinding from Ingot Chip Process Parameters

| Jar Volume | 1000 | milliliters |
|---|---|---|
| Jar Material | 302 Stainless Steel | |
| Agitating Ball | 32 | grams |
| Mass | | |
| Agitating Ball | 20 | millimeters |
| Diameter | | |
| Agitating Ball | 316 Stainless Steel | |
| Material | | |
| Agitating Ball to | 4:1 | |
| Sample Mass | | |
| Ratio | | |
| Vacuum | No | |
| Cover Gas | No | |
| Back Pressure | None | |
| Sample Weight | 200 | grams |
| Milling Time | 30 | minutes |
| Milling RPMs | 550 rotations per | |
| | minute | |
| Milling Direction | Clockwise | |
| | (5-minute intervals | |
| Milling Direction | Counterclockwise | |
| | (5-minute intervals) | |
| Milling Pause | 10 | seconds |

Composite Particle Elemental Composition

| | | | |
|---|---|---|---|
| Magnesium | 89.8% | 179.6 | grams |
| Aluminum | 9.0% | 18.0 | grams |
| Zinc | 0.7% | 1.4 | grams |
| Manganese | 0.4% | 0.8 | grams |
| Silicon | 0.1% | 0.2 | grams |
| Nanodiamond Terminated | 0.4% | 0.8 | grams |
| with Amine Functional | | | |
| Group (2-5 nanometer | | | |
| spherical) | | | |

Mechanical Grinding from Ingot Chip Process Parameters

| Jar Volume | 1000 | milliliters |
|---|---|---|
| Jar Material | 302 Stainless Steel | |
| Agitating Ball 1 Mass | 32 | grams |
| Agitating Ball 1 | 20 | millimeters |
| Diameter | | |
| Agitating Ball 1 to | 4:1 | |
| Sample Mass Ratio | | |
| Agitating Ball 2 Mass | 4 | grams |
| Agitating Ball 2 | 10 | millimeters |
| Diameter | | |
| Agitating Ball 2 to | 2.5:1 | |
| Sample Mass Ratio | | |
| Agitating Ball Material | 316 Stainless Steel | |
| Vacuum | No | |
| Cover Gas | Nitrogen | |
| Back Pressure | 15 Pounds per | |
| | Square Inch | |
| Sample Weight | 200 | grams |
| Milling Time | 360 | minutes |
| Milling RPMs | 550 rotations | |
| | per minute | |
| Milling Direction | Clockwise | |
| | (30-minute intervals | |
| Milling Direction | Counterclockwise | |
| | (30-minute intervals) | |
| Milling Pause | 60 | seconds |

| | |
|---|---|
| | Percent Yield from |
| Filter Mesh | Mechanical Alloying |
| Size | Process |

| | | |
|---|---|---|
| +40 | Mesh | 0.1% |
| +100 | Mesh | 43.3% |
| +200 | Mesh | 35.1% |
| +325 | Mesh | 15.7% |
| −325 | Mesh | 5.8% |

| | |
|---|---|
| Apparent | 0.866 grams per centimeter cubed |
| Density | |

### Example 4

Ingot Chip Elemental Composition

| | | | |
|---|---|---|---|
| Magnesium | 89.8% | 179.6 | grams |
| Aluminum | 9.0% | 18.0 | grams |
| Zinc | 0.7% | 1.4 | grams |
| Manganese | 0.4% | 0.8 | grams |
| Silicon | 0.1% | 0.2 | grams |

Mechanical Grinding from Ingot Chip Process Parameters

| Jar Volume | 1000 | milliliters |
|---|---|---|
| Jar Material | 302 Stainless Steel | |
| Agitating Ball Mass | 32 | grams |
| Agitating Ball | 20 | millimeters |
| Diameter | | |
| Agitating Ball | 316 Stainless Steel | |
| Material | | |
| Agitating Ball to | 4:1 | |
| Sample Mass Ratio | | |
| Vacuum | No | |
| Cover Gas | No | |
| Back Pressure | None | |
| Sample Weight | 200 | grams |
| Milling Time | 30 | minutes |
| Milling RPMs | 550 rotations | |
| | per minute | |
| Milling Direction | Clockwise | |
| | (5-minute intervals | |
| Milling Direction | Counterclockwise | |
| | (5-minute intervals) | |
| Milling Pause | 10 | seconds |

Composite Particle Elemental Composition

| | | | |
|---|---|---|---|
| Magnesium | 89.8% | 179.6 | grams |
| Aluminum | 9.0% | 18.0 | grams |
| Zinc | 0.7% | 1.4 | grams |
| Manganese | 0.4% | 0.8 | grams |
| Silicon | 0.1% | 0.2 | grams |
| Nanodiamond | 0.4% | 0.8 | grams |
| Terminated (2-5 | | | |
| nanometer | | | |
| spherical) | | | |

Mechanical Grinding from Ingot Chip Process Parameters

| Jar Volume | 1000 | milliliters |
|---|---|---|
| Jar Material | 302 Stainless Steel | |
| Agitating Ball 1 Mass | 32 | grams |
| Agitating Ball 1 | 20 | millimeters |
| Diameter | | |
| Agitating Ball 1 to | 4:1 | |
| Sample Mass Ratio | | |
| Agitating Ball 2 Mass | 4 | grams |
| Agitating Ball 2 | 10 | millimeters |
| Diameter | | |
| Agitating Ball 2 to | 2.5:1 | |
| Sample Mass Ratio | | |
| Agitating Ball | 316 Stainless Steel | |
| Material | | |
| Vacuum | No | |
| Cover Gas | Nitrogen | |
| Back Pressure | 15 Pounds per | |
| | Square Inch | |
| Sample Weight | 200 | grams |
| Milling Time | 360 | minutes |
| Milling RPMs | 550 rotations | |
| | per minute | |
| Milling Direction | Clockwise | |
| | (30-minute intervals | |
| Milling Direction | Counterclockwise | |
| | (30-minute intervals) | |
| Milling Pause | 60 | seconds |

| | |
|---|---|
| | Percent Yield from |
| Filter Mesh | Mechanical Alloying |
| Size | Process |

| | | |
|---|---|---|
| +40 | Mesh | 0.1% |
| +100 | Mesh | 43.3% |
| +200 | Mesh | 35.1% |
| +325 | Mesh | 15.7% |
| −325 | Mesh | 5.8% |

| | |
|---|---|
| Apparent | 0.866 grams per centimeter cubed |
| Density | |

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A nanomaterial comprising:
a powder comprised of composite particles, each of the composite particles having a magnesium-rich metal core particle defining an external surface and exposed nanodiamond particles bonded to the external surface.

2. The nanomaterial as recited in claim 1, wherein the exposed nanodiamond particles are mechanically bonded to the external surface.

3. The nanomaterial as recited in claim 1, wherein the exposed nanodiamond particles are electrically bonded to the external surface.

4. The nanomaterial as recited in claim 1, wherein each of the exposed nanodiamond particles is spherical, has a diameter of 1 nanometer to 30 nanometers, and has an amorphous carbon exterior.

5. The nanomaterial as recited in claim 4, wherein the amorphous carbon exterior is functionalized such that each of the nanodiamond particles has a negative zeta potential.

6. The nanomaterial as recited in claim 5, wherein the negative zeta potential is −30 millivolts or greater and is less than zero millivolts.

7. The nanomaterial as recited in claim 5, wherein the amorphous carbon exterior is functionalized with amine functional groups.

8. The nanomaterial as recited in claim 1, wherein the magnesium-rich metal core particle is pure magnesium.

9. The nanomaterial as recited in claim 1, wherein the magnesium-rich metal core particle is a magnesium alloy.

10. The nanomaterial as recited in claim 9, wherein the magnesium alloy has one or more alloy elements independently selected from the group consisting of aluminum, zinc, manganese, silicon, gadolinium, yttrium, and neodymium.

11. The nanomaterial as recited in claim 1, wherein each of the composite particles has, by weight, from 0.1% to 30% of the exposed nanodiamond particles.

12. The nanomaterial as recited in claim 11, wherein each of the composite particles has, by weight, from 0.2% to 0.4% of the exposed nanodiamond particles.

13. The nanomaterial as recited in claim 1, wherein the magnesium-rich metal core particles without the nanodiamond particles bonded to the external surface have a core particle ignition temperature, and the composite particles have a composite particle ignition temperature that is greater than the core particle ignition temperature.

14. A method for fabricating a nanomaterial, the method comprising:
introducing magnesium-rich metal core particles, nanodiamond particles, and milling media into a milling container, the magnesium-rich metal core particles are comprised of particle sizes that are larger than −100 Mesh; and
rotating the milling container that has the magnesium-rich metal core particles, the nanodiamond particles, and the milling media, the milling media acting to impact the magnesium-rich metal core particles and the nanodiamond particles and bond the nanodiamond particles to an external surface of the magnesium-rich metal core particles to thereby form composite particles of the magnesium-rich metal core particles and nanodiamond particles bonded and exposed on the external surface.

15. The method as recited in claim 14, wherein the milling container includes an inert cover gas during the rotating, the rotating produces heat in the milling container and, after conclusion of the rotating, further including subjecting the composite particles in the milling container to a cooling cycle to cool the composite particles to a predetermined temperature in the milling container while under the inert cover gas in the milling container, followed by venting the milling container to ambient air once the predetermined temperature is reached.

16. The method as recited in claim 15, wherein the cooling cycle is selected based upon amounts, by weight, of the nanodiamond particles and the magnesium-rich metal core particles introduced into the milling container.

17. The method as recited in claim 14, wherein the milling media includes milling balls, and a weight ratio of the milling balls to a combined weight of the magnesium-rich metal core particles and the nanodiamond particles is from 1:1 to 50:1.

18. The method as recited in claim 14, further comprising introducing stearic acid into the milling container with the magnesium-rich metal core particles, the stearic acid reducing adherence of the composite particles to the milling media.
